(19) United States
(12) Patent Application Publication
(10) Pub. No.: US 2026/0346203 A1
(43) Pub. Date: Nov. 5, 2026

(54) AN EXHAUST AFTERTREATMENT SYSTEM COMPRISING THREE-WAY CATALYSTS

(71) Applicant: BASF Mobile Emissions Catalysts LLC, lselin, NJ (US)

(72) Inventors: Xiaolai ZHENG, Iselin, NJ (US); Shiang SUNG, Iselin, NJ (US); Stephen C JOHNSON, Wixom, MI (US); Daniel Lee COHEN, Wixom, MI (US); Yipeng SUN, Iselin, NJ (US)

(21) Appl. No.: 19/112,477

(22) PCT Filed: Sep. 20, 2023
(86) PCT No.: PCT/EP2023/075905

§ 371 Date: Mar. 17, 2025

(30) Foreign Application Priority Data
Sep. 20, 2022 (EP) 22196453.9

(51) Int. Cl. B01D 53/94; B01J 23/63; B01J 35/00; B01J 35/30; F01N 3/10; F01N 3/28; F01N 13/00

(52) U.S. Cl. CPC B01D 53/9477; B01D 53/945; B01D 53/9468; B01D 53/9472; B01J 23/63; B01J 35/19; B01J 35/394; F01N 3/101; F01N 3/2803; F01N 13/0093; B01D 2255/1021; B01D 2255/1023; B01D 2255/1025; B01D 2255/9022; B01D 2255/9032; B01D 2257/404; B01D 2257/502; B01D 2257/702; B01D 2258/012; F01N 2370/02

(57) ABSTRACT

The present invention provides an exhaust aftertreatment system comprising a first three-way catalyst deposited at least on a part of a first substrate; and a second three-way catalyst deposited at least on a part of a second substrate, wherein the first three-way catalyst comprises platinum supported on alumina, ceria-zirconia mixed oxide, ceria-alumina composite, or any combination thereof, palladium supported on alumina, ceria-zirconia mixed oxide, ceria-alumina composite, or any combination thereof, and rhodium supported on alumina, ceria-zirconia mixed oxide, ceria-alumina composite, or any combination thereof, wherein the second three-way catalyst comprises platinum supported on alumina, ceriazirconia mixed oxide, ceria-alumina composite or any combination thereof.

### FIELD OF THE INVENTION

The presently claimed invention relates to an exhaust aftertreatment system comprising at least two three-way catalysts (TWC's). Particularly, the presently claimed invention relates to the exhaust aftertreatment system comprising at least two three-way catalysts (TWC's) of which one TWC is located in an upstream position and the other TWC is located in a downstream position.

### BACKGROUND OF THE INVENTION

Exhaust gas from vehicles powered by gasoline engines is typically treated with one or more three-way conversion (TWC) automotive catalysts, which are effective to abate pollutants of nitrogen oxides (NOx), carbon monoxide (CO), and hydrocarbon (HC) in the engine exhaust. For example, a typical exhaust after-treatment system for a gasoline engine consists of two TWC catalysts, namely, a first/upstream TWC catalyst mounted in a position near the exhaust manifold and the engine compartment (the close-coupled position, CC), and a second/downstream TWC catalyst placed in a position either directly next to the first TWC catalyst (the second close-coupled position, CC2) or underneath the vehicle body (the underfloor position, UF).

A conventional TWC catalyst comprises two platinum group metals (PGMs), namely palladium (Pd) and rhodium (Rh) as active catalytic components. These platinum group metals are supported on oxygen storage components (OSCs) and/or refractory metal oxide supports.

DE 10 2019 208436 A1 relates to an aftertreatment method for a lean burn engine. The method is designed to control an aftertreatment system sequentially equipped with an ammonia production catalyst module, a selective catalytic reduction catalyst, and a CO clean-up catalyst on an exhaust pipe through which an exhaust gas flows.

US 2010/061903 A1 relates to a catalyst system to be used in an automobile exhaust gas purification apparatus, comprised of using two or more exhaust gas purification catalysts comprising a first catalyst supported on an inorganic structural carrier, and a second catalyst supported on a part of the inorganic structural carrier positioned at the downstream side.

US 2002/048542 A1 discloses a catalytic trap for conversion of NOx in an exhaust gas stream comprising a catalytic trap material and a refractory carrier member on which the catalytic trap material is coated.

US 2009/042722 A1 discloses a method for preparing a catalyst having a base metal undercoat with an oxygen storage component.

The existing exhaust after-treatment system for a gasoline engine utilizes high loading of palladium which renders the exhaust system least cost effective. That has led to a renewed interest in the automobile industry to use substantial amount of Pt for TWC applications, given the current low price of Pt in the market. Accordingly, the present invention is focused on providing a high-performance, cost-effective emission control system comprising at least two three-way catalysts (TWC's) with use of a substantial amount of Pt.

### OBJECTS OF THE INVENTION

The object of the presently claimed invention is to provide an exhaust aftertreatment system which provides comparable or improved performance when compared with a conventional Pd/Rh based TWC system.

Another object of the presently claimed invention is to provide the exhaust aftertreatment system which delivers improved NOx performance during fuel-cut events.

Still another object of the presently claimed invention is to provide the exhaust aftertreatment system which allows a substantial replacement of Pd with Pt (20-80%) thereby rendering the system cost-effective.

### SUMMARY OF THE INVENTION

The present invention provides an exhaust aftertreatment system comprising a first three-way catalyst deposited at least on a part of a first substrate; and a second three-way catalyst deposited at least on a part of a second substrate,
wherein the first three-way catalyst comprises platinum supported on alumina, ceria-zirconia mixed oxide, ceria-alumina composite, or any combination thereof, palladium supported on alumina, ceria-zirconia mixed oxide, ceria-alumina composite, or any combination thereof, and rhodium supported on alumina, ceria-zirconia mixed oxide, ceria-alumina composite, or any combination thereof,
wherein the second three-way catalyst comprises platinum supported on alumina, ceria-zirconia mixed oxide, ceria-alumina composite, or any combination thereof.

The present invention also provides a method of reducing the emissions of hydrocarbons, carbon monoxide, and nitrogen oxide levels in a gaseous exhaust stream, the method comprising contacting a gaseous exhaust stream with exhaust aftertreatment system according to the present invention to reduce the levels of hydrocarbons, carbon monoxide, and nitrogen oxide in the exhaust gas.

The present invention further provides use of the exhaust aftertreatment system according to the present invention for purifying a gaseous exhaust stream comprising hydrocarbons, carbon monoxide, and nitrogen oxide.

### BRIEF DESCRIPTION OF THE DRAWINGS

In order to provide an understanding of the embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings:

FIG. 1 illustrates configurations of TWC catalyst systems.

FIG. 2 illustrates FTP-75 Tailpipe cumulative NOx emissions of Examples S5 and S6 collected on a SULEV30 vehicle calibrated with frequent fuel-cut events.

FIG. 3A is a perspective view of a honeycomb-type substrate carrier which may comprise the catalyst composition in accordance with one embodiment of the presently claimed invention.

FIG. 3B is a partial cross-section view enlarged relative to FIG. 3A and taken along a plane parallel to the end faces of the substrate carrier of FIG. 3A, which shows an enlarged view of a plurality of the gas flow passages shown in FIG. 3A.

FIG. 4 is a cutaway view of a section enlarged relative to FIG. 3A, wherein the honeycomb-type substrate in FIG. 3A represents a wall flow filter substrate monolith.

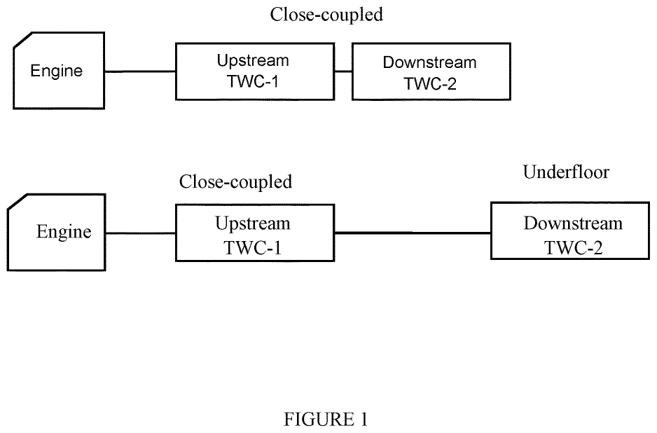

### DETAILED DESCRIPTION

The presently claimed invention will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

### DEFINITIONS

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

In the context of the present invention the term “washcoat” is interchangeably used for “first three-way catalyst” or “the second three-way catalyst” which forms one or more layers on a part of a respective substrate. As used herein, the term “washcoat” has its usual meaning in the art of a thin, adherent coating of a catalytic or other material applied to a substrate material. Generally, a washcoat is formed by preparing a slurry containing a certain solid content (e.g., 15-60% by weight) of particles in a liquid vehicle, which is then coated onto a substrate and dried to provide a washcoat layer on the respective substrate.

The term “three-way conversion catalyst” or TWC catalyst refers to a catalyst that simultaneously promotes a) reduction of nitrogen oxides to nitrogen and oxygen; b) oxidation of carbon monoxide to carbon dioxide; and c) oxidation of unburnt hydrocarbons to carbon dioxide and water.

The term “NOx” refers to nitrogen oxide compounds, such as NO and/or NO₂.

As used herein, the term “stream” broadly refers to any combination of flowing gas that may contain solid or liquid particulate matters.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

The term “close-coupled” refers to a position of one or more catalytic converters which are placed in a proximity to the engine-out manifold.

The term “underfloor” refers to a position of one or more catalytic converters which are placed away from the close-coupled position. Usually, the underfloor catalytic converter is placed in the underfloor of the vehicle body between a close-coupled catalytic convert and a muffler.

In the context of the present invention, the amount of platinum group metal/s such as platinum/palladium/rhodium, and/or support material such as ceria-zirconia mixed oxide, ceria-alumina composite, alumina etc is calculated as weight %, based on the total weight of the washcoat present on the substrate. i.e., the amount is calculated without considering the substrate amount, though substrate is part of the overall catalytic system.

The present invention focused on addressing low NOx performance during fuel-cut events associated with the existing exhaust aftertreatment system and improving the overall performance despite a substantial replacement of Pd with Pt (20-80%).

The present invention in first aspect provides an exhaust aftertreatment system comprising:
a. a first three-way catalyst deposited at least on a part of a first substrate; and
b. a second three-way catalyst deposited at least on a part of a second substrate, wherein the first three-way catalyst comprises:
   i. platinum supported on alumina, ceria-zirconia mixed oxide, ceria-alumina composite or any combination thereof,
   ii. palladium supported on alumina, ceria-zirconia mixed oxide, ceria-alumina composite or any combination thereof, and
   iii. rhodium supported on alumina, ceria-zirconia mixed oxide, ceria-alumina composite or any combination thereof,
wherein the second three-way catalyst comprises platinum supported on alumina, ceria-zirconia mixed oxide, ceria-alumina composite or any combination thereof.

### Amount of Platinum Group Metals:

The amount of platinum supported on alumina, ceria-zirconia mixed oxide, ceria-alumina composite, or any combination thereof in the first three-way catalyst and the second three-way catalyst is preferably in the range of 0.01 to 5.0 wt. %, based on the total weight of the first three-way catalyst and the second three-way catalyst. More preferably, the amount of platinum supported on alumina, ceria-zirconia mixed oxide, ceria-alumina composite, or any combination thereof in the first three-way catalyst and the second three-way catalyst is in the range of 0.02 to 3.0 wt. %, based on the total weight of the first three-way catalyst and the second three-way catalyst. Even more preferably, the amount of platinum supported on alumina, ceria-zirconia mixed oxide, ceria-alumina composite, or any combination thereof in the first three-way catalyst and the second three-way catalyst is in the range of 0.03 to 2.5 wt. %, based on the total weight of the first three-way catalyst and the second three-way catalyst.

The amount of palladium supported on alumina, ceria-zirconia mixed oxide, ceria-alumina composite, or any combination thereof in the first three-way catalyst and the second three-way catalyst is preferably in the range of 0.01 to 4.0 wt. %, based on the total weight of the first three-way catalyst and the second three-way catalyst. More preferably, the amount of palladium supported on alumina, ceria-zirconia mixed oxide, ceria-alumina composite, or any combination thereof in the first three-way catalyst and the second three-way catalyst is in the range of 0.02 to 3.0 wt. %, based on the total weight of the first three-way catalyst and the second three-way catalyst. Even more preferably, the amount of palladium supported on alumina, ceria-zirconia mixed oxide, ceria-alumina composite, or any combination thereof in the first three-way catalyst and the second three-way catalyst is in the range of 0.02 to 2.0 wt. %, based on the total weight of the first three-way catalyst and the second three-way catalyst.

The amount of rhodium supported on alumina, ceria-zirconia mixed oxide, ceria-alumina composite, or any combination thereof in the first three-way catalyst and the second three-way catalyst is preferably in the range of 0.01 to 2.0 wt. %, based on the total weight of the first three-way catalyst and the second three-way catalyst. More preferably, the amount of rhodium supported on alumina, ceria-zirconia mixed oxide, ceria-alumina composite, or any combination thereof in the first three-way catalyst and the second three-way catalyst is in the range of 0.01 to 1.5 wt. %, based on the total weight of the first three-way catalyst and the second three-way catalyst. Even more preferably, the amount of rhodium supported on alumina, ceria-zirconia mixed oxide, ceria-alumina composite, or any combination thereof in the first three-way catalyst and the second three-way catalyst is in the range of 0.01 to 1.0 wt. %, based on the total weight of the first three-way catalyst and the second three-way catalyst.

### Weight Ratios:

Preferably, the weight ratio of platinum supported on alumina, ceria-zirconia mixed oxide, ceria-alumina composite, or any combination thereof in the first three-way catalyst to the platinum supported on alumina, ceria-zirconia mixed oxide, ceria-alumina composite, or any combination thereof in the second three-way catalyst is greater than 1.

More preferably, the weight ratio of platinum supported on alumina, ceria-zirconia mixed oxide, ceria-alumina composite, or any combination thereof in the first three-way catalyst to the platinum supported on alumina, ceria-zirconia mixed oxide, ceria-alumina composite, or any combination thereof in the second three-way catalyst is in the range of 2:1 to 20:1.

Even more preferably, the weight ratio of platinum supported on alumina, ceria-zirconia mixed oxide, ceria-alumina composite, or any combination thereof in the first three-way catalyst to the platinum supported on alumina, ceria-zirconia mixed oxide, ceria-alumina composite, or any combination thereof in the second three-way catalyst is in the range of 2.5:1 to 12:1.

Preferably, the weight ratio of the rhodium supported on alumina, ceria-zirconia mixed oxide, ceria-alumina composite, or any combination thereof in the first three-way catalyst to the rhodium supported on alumina, ceria-zirconia mixed oxide, ceria-alumina composite, or any combination thereof in the second three-way catalyst is in the range of 1:3 to 50:1, more preferably in the range of 1:1 to 50:1.

Even more preferably, the weight ratio of the rhodium supported on alumina, ceria-zirconia mixed oxide, ceria-alumina composite, or any combination thereof in the first three-way catalyst to the rhodium supported on alumina, ceria-zirconia mixed oxide, ceria-alumina composite, or any combination thereof in the second three-way catalyst is in the range of 1:2 to 20:1, more preferably in the range of 1:1 to 20:1. Even more preferably, the weight ratio of the rhodium supported on alumina, ceria-zirconia mixed oxide, ceria-alumina composite, or any combination thereof in the first three-way catalyst to the rhodium supported on alumina, ceria-zirconia mixed oxide, ceria-alumina composite, or any combination thereof in the second three-way catalyst is in the range of 1:1.5 to 4:1, more preferably in the range of 1:1 to 4:1.

Preferably, the weight ratio of the total amount of platinum, palladium and rhodium, each supported on alumina, ceria-zirconia mixed oxide, ceria-alumina composite, or any combination thereof in the first three-way catalyst to the total amount of platinum optionally with rhodium and palladium, each supported on alumina, ceria-zirconia mixed oxide, ceria-alumina composite, or any combination thereof in the second three-way catalyst is in the range of 1.1:1 to 20:1.

More preferably, the weight ratio of the total amount of platinum, palladium and rhodium, each supported on alumina, ceria-zirconia mixed oxide, ceria-alumina composite, or any combination thereof in the first three-way catalyst to the total amount of platinum optionally with rhodium and palladium, each supported on alumina, ceria-zirconia mixed oxide, ceria-alumina composite, or any combination thereof in the second three-way catalyst is in the range of 4:1 to 20:1.

Even more preferably, the weight ratio of the total amount of platinum, palladium and rhodium, each supported on alumina, ceria-zirconia mixed oxide, ceria-alumina composite, or any combination thereof in the first three-way catalyst to the total amount of platinum optionally with rhodium and palladium, each supported on alumina, ceria-zirconia mixed oxide, ceria-alumina composite, or any combination thereof in the second three-way catalyst is in the range of 8:1 to 12:1.

### Support Materials:

A “support” in a catalytic material or catalyst composition or catalyst washcoat refers to a material such as alumina, ceria-alumina composite, ceria-zirconia mixed oxide etc. that receives metals (e.g., PGMs), stabilizers, promoters, binders, and the like through precipitation, association, dispersion, impregnation, or other suitable methods.

The term “supported” throughout this application has the general meaning as in the field of heterogenous catalysis. In general, the term “supported” refers to an affixed catalytically active species or its respective precursor to a support material. The support material may be inert or participate in the catalytic reaction. Commonly supported catalysts are prepared by impregnation methods or co-precipitation methods and optional subsequent calcination.

### Ceria-Alumina Composite:

Ceria-alumina composite is a composite in which CeO₂ is distributed on the surface of alumina and/or in the bulk as particles and/or nano clusters. Each oxide may have its distinct chemical and solid physical state. The surface CeO₂ modification of alumina can be in the form of discrete moieties (particles or clusters) or in the form of a layer of ceria that covers the surface of alumina partially or completely.

Preferably, the amount of the ceria-alumina composite present in the first three-way catalyst and the second three-way catalyst is in the range of 5.0 to 80 wt. %, based on the total weight of the first three-way catalyst and the second three-way catalyst. More preferably, the amount of the ceria-alumina composite present in the first three-way catalyst and the second three-way catalyst is in the range of 10 to 60 wt. %, based on the total weight of the first three-way catalyst and the second three-way catalyst. Even more preferably, the amount of the ceria-alumina composite present in the first three-way catalyst and the second three-way catalyst is in the range of 15 to 60 wt. %, and more preferably in the range of 15 to 40 wt. %, based on the total weight of the first three-way catalyst and the second three-way catalyst.

The amount of CeO₂ (cerium oxide) in the ceria-alumina composite present in the first three-way catalyst or the second three-way catalyst is preferably 1.0 to 60 wt. %, based on the total weight of the ceria-alumina composite in the respective catalyst. More preferably, the CeO₂ in the ceria-alumina composite present in the first three-way catalyst or the second three-way catalyst is 10 to 50 wt. %, based on the total weight of the ceria-alumina composite in the respective catalyst. Even more preferably, the CeO₂ in the ceria-alumina composite present in the first three-way catalyst or the second three-way catalyst is 15 to 50 wt. %, based on the total weight of the ceria-alumina composite in the respective catalyst.

The amount of Al₂O₃ (aluminium oxide) in the ceria-alumina composite present in the first three-way catalyst or the second three-way catalyst is preferably 40 to 99 wt. % based on the total weight of the ceria-alumina composite in the respective catalyst. More preferably, the Al₂O₃ in the ceria-alumina composite present in the first three-way catalyst or the second three-way catalyst is 50 to 90 wt. % based on the total weight of the ceria-alumina composite in the respective catalyst. Even more preferably, the Al₂O₃ in the ceria-alumina composite present in the first three-way catalyst or the second three-way catalyst is 50 to 85 wt. % based on the total weight of the ceria-alumina composite in the respective catalyst.

Preferably, the average particle size of ceria in the ceria-alumina composite is less than 200 nm. More preferably, the particles size is in the range of 5.0 nm to 50 nm. The particle size is determined by transition electron microscopy.

The ceria-alumina composite present in the first three-way catalyst or the second three-way catalyst may comprise a dopant selected from zirconia, lanthana, titania, hafnia, magnesia, calcia, strontian, baria or any combination thereof. The total amount of dopant in the ceria-alumina composite is preferably in the range of 0.001 to 15 wt. % based on the total weight of the ceria-alumina composite in the respective catalyst.

The ceria-alumina composite can be made by methods known to the person skilled in the art like co-precipitation or surface modification. In these methods, a suitable cerium containing precursor is brought into contact with a suitable aluminium containing precursor and the so obtained mixture is then transformed into the ceria-alumina composite. Suitable cerium containing precursors are for example water soluble cerium salts and colloidal ceria suspension. Ceria-alumina can also be prepared by the atomic layer deposition method, where a ceria compound selectively reacts with an alumina surface, which after calcination forms ceria on the alumina surface. This deposition/calcination step can be repeated until a layer of desired thickness is reached. Suitable aluminium containing precursors are for example aluminium oxides like gibbsite, boehmite gamma alumina, delta alumina or theta alumina or their combinations. Transformation of the so obtained mixture into the ceria-alumina composite can then be achieved by a calcinations step of the mixture.

### Ceria-Zirconia Mixed Oxide (CZO):

The term of complex metal oxide refers to a mixed metal oxide that contains oxygen anions and at least two different metal cations. In the ceria-zirconia mixed oxide, cerium cations, zirconium cations are distributed within the oxide lattice structure. The terms “complex oxide” and “mixed oxide” can be used interchangeably. As the metal cations are distributed within the oxide lattice structure, these structures are also commonly referred to as solid solutions.

Preferably, the amount of the ceria-zirconia mixed oxide present in the first three-way catalyst and the second three-way catalyst is 20 to 80 wt. %, based on the total weight of the first three-way catalyst and the second three-way catalyst. More preferably, the amount of ceria-zirconia mixed oxide present in the first three-way catalyst and the second three-way catalyst is in the range of 25 to 75 wt. %, based on the total weight of the first three-way catalyst and the second three-way catalyst. Even more preferably, the amount of ceria-zirconia mixed oxide present in the first three-way catalyst and the second three-way catalyst is in the range of 30 to 75 wt. %, and more preferably in the range of 40 to 60 wt. %, based on the total weight of the first three-way catalyst and the second three-way catalyst.

Preferably, ceria (calculated as CeO₂) of the ceria-zirconia mixed oxide present in the first three-way catalyst or the second three-way catalyst is present in an amount of 10 to 60 wt. %, based on the total weight of the ceria-zirconia mixed oxide present in the respective catalyst and zirconia (calculated as ZrO₂) of the ceria-zirconia mixed oxide present in the first three-way catalyst or the second three-way catalyst is present in an amount of 40 to 90 wt. %, based on the total weight of the ceria-zirconia mixed oxide present in the respective catalyst.

More preferably, ceria (calculated as CeO₂) of the ceria-zirconia mixed oxide present in the first three-way catalyst or the second three-way catalyst is present in an amount of 20 to 50 wt. %, based on the total weight of the ceria-zirconia mixed oxide in the respective catalyst and zirconia (calculated as ZrO₂) of the ceria-zirconia mixed oxide present in the first three-way catalyst or the second three-way catalyst is present in an amount of 50 to 80 wt. %, based on the total weight of the ceria-zirconia mixed oxide in the respective catalyst.

Even more preferably, ceria (calculated as CeO₂) of the ceria-zirconia mixed oxide present in the first three-way catalyst or the second three-way catalyst is present in an amount of 30 to 50 wt. %, based on the total weight of the ceria-zirconia mixed oxide in the respective catalyst and zirconia (calculated as ZrO₂) of the ceria-zirconia mixed oxide present in the first three-way catalyst or the second three-way catalyst is present in an amount of 50 to 70 wt. %, based on the total weight of the ceria-zirconia mixed oxide in the respective catalyst.

The ceria-zirconia mixed oxide serves as oxygen storage component. The term “oxygen storage component” (OSC) refers to an entity that has a multi-valence state and can actively react with reductants such as carbon monoxide (CO) and/or hydrogen under reduction conditions and then react with oxidants such as oxygen or nitrogen oxides under oxidative conditions.

In a preferred embodiment, the ceria-zirconia mixed oxide present in the first three-way catalyst or the second three-way catalyst comprises a dopant selected from lanthana, titania, hafnia, magnesia, calcia, strontia, baria, yttrium, hafnium, praseodymium, neodymium, or any combinations thereof. The dopant metal may be incorporated in a cationic form into the crystal structure of the complex metal oxide, may be deposited in an oxidic form on the surface of the complex metal oxide, or may be present in the oxidic form as a blend of mixtures of both dopants and complex metal oxide on a micro-scale, so to say in a composite form with the complex metal oxide. Preferably, the dopant(s) are comprised in an amount of 1.0 to 20 wt. %, or more preferably in an amount of 5.0 to 15 wt. %, based on the total weight of the ceria-zirconia mixed oxide present in the respective catalyst.

### Alumina:

Alumina present in the first three-way catalyst or the second three-way catalyst is preferably gamma alumina or activated alumina. It typically exhibits a BET surface area of fresh material in excess of 60 square meters per gram (“m²/g”), often up to about 200 m²/g or higher. Activated alumina is usually a mixture of the gamma and delta phases of alumina, but may also contain substantial amounts of eta, kappa and theta alumina phases. Preferably, the activated alumina is high bulk density gamma-alumina, low or medium bulk density large pore gamma-alumina, low bulk density large pore boehmite or gamma-alumina.

Preferably, the amount of alumina present in the first three-way catalyst and the second three-way catalyst is in the range of 5.0 to 70 wt. %, based on the total weight of the first three-way catalyst and the second three-way catalyst. More preferably, the amount of the alumina present in the first three-way catalyst and the second three-way catalyst is in the range of 5.0 to 20 wt. %, based on the total weight of the first three-way catalyst and the second three-way catalyst. Also preferred is that the amount of the alumina present in the first three-way catalyst and the second three-way catalyst is in the range of 10 to 60 wt. %, based on the total weight of the first three-way catalyst and the second three-way catalyst. Most preferably, the amount of alumina present in the catalytic article is in the range of 15 to 60 wt. %, based on the total weight of the first three-way catalyst and the second three-way catalyst.

Alumina present in the first three-way catalyst and the second three-way catalyst is preferably doped with a dopant selected from barium, lanthana, zirconia, neodymian, yttria, ceria, titania or any combination thereof, wherein the amount of the dopant is preferably 1.0 to 30 wt. % based on the total weight of the alumina and dopant present in the respective catalyst. More preferably, alumina doped with dopant/s is selected from lanthana-alumina, titania-alumina, ceria-zirconia-alumina, zirconia-alumina, lanthana-zirconia-alumina, baria-alumina, baria-lanthana-alumina, baria-lanthana-neodymia-alumina, yttrium-alumina, or any combination thereof.

### Substrate:

Substrates of the first three-way catalyst and the second three-way catalyst of the presently claimed invention, namely a first substrate and a second substrate may be constructed of any material typically used for preparing automotive catalysts. In a preferred embodiment, the substrate is a ceramic substrate, metal substrate, ceramic foam substrate, polymer foam substrate or a woven fiber substrate. In a more preferred embodiment, the substrate is a ceramic or a metal monolithic honeycomb structure.

The substrate provides a plurality of wall surfaces upon which the catalytic layer/s or washcoat described herein above are applied and adhered, thereby acting as a carrier for the catalytic material.

Preferable metallic substrates include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt. % of the alloy. e.g., 10-25 wt. % of chromium, 3-8% of aluminium, and up to 20 wt. % of nickel. The alloys may also contain small or trace amounts of one or more metals such as manganese, copper, vanadium, titanium, and the like. The surface of the metal substrate may be oxidized at high temperature, e.g., 1000 °C and higher, to form an oxide layer on the surface of the substrate, improving the corrosion resistance of the alloy and facilitating adhesion of the washcoat layer to the metal surface.

Preferable ceramic materials used to construct the substrate may include any suitable refractory material, e.g., cordierite, mullite, cordierite-alumina, silicon nitride, zircon mullite, spodumene, alumina-silica magnesia, zircon silicate, sillimanite, magnesium silicates, zircon, petalite, alumina, aluminosilicates, and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which are of any suitable cross-sectional shape, such as trapezoidal, rectangular, square, sinusoidal, hexagonal, oval, circular, and the like. Such structures contain from about 60 to about 1200 or more gas inlet openings (i.e., “cells”) per square inch of cross section (cpsi), more usually from about 300 to 900 cpsi. The wall thickness of flow-through substrates can vary, with a typical range being between 0.002 and 0.1 inches. A representative commercially available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry. In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminium-titanate, silicon carbide and silicon nitride are also used as wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls. In one embodiment, the substrate has a flow through ceramic honeycomb structure, a wall-flow ceramic honeycomb structure, or a metal honeycomb structure.

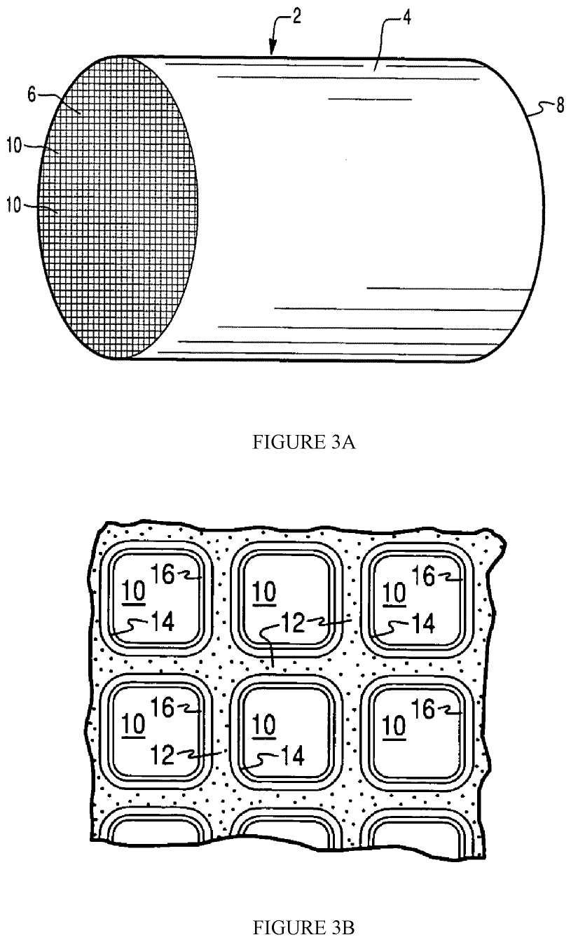

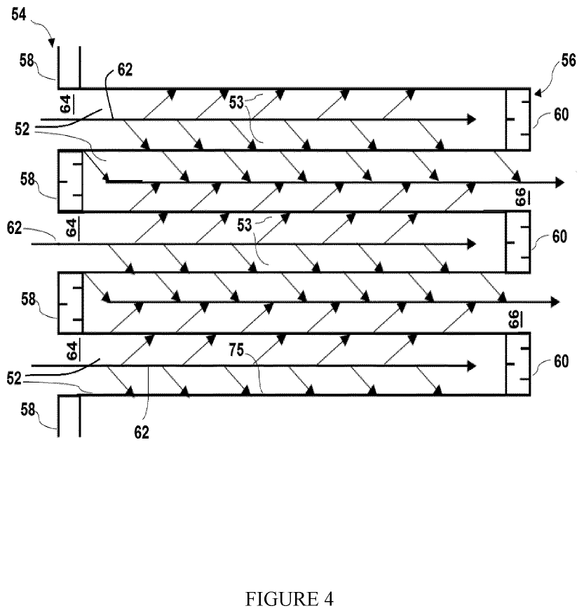

FIGS. 3A and 3B illustrate an exemplary substrate 2 in the form of a flow-through substrate coated with washcoat compositions/catalytic layer/s as described herein. Referring to FIG. 3A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 3B, flow passages 10 are formed by walls 12 and extend through substrate 2 from upstream end face 6 to downstream end face 8, the passages 10 being unobstructed so as to permit the flow of a fluid, e.g., a gas stream, longitudinally through substrate 2 via gas flow passages 10 thereof. As more easily seen in FIG. 3B, walls 12 are so dimensioned and configured that gas flow passages 10 have a substantially regular polygonal shape. As shown, the washcoat compositions/catalytic layers can be applied in multiple, distinct layers if desired. In the illustrated embodiment, the washcoats consist of a discrete first washcoat layer 14 adhered to the walls 12 of the substrate member and a second discrete washcoat layer 16 coated over the first washcoat layer 14. In one embodiment, the presently claimed invention is also practiced with two or more (e.g., 3, or 4) washcoat layers and is not limited to the illustrated two-layer embodiment.
FIG. 4 illustrates an exemplary substrate 2 in the form of a wall flow filter substrate coated with a washcoat composition as described herein. As seen in FIG. 4, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58 and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalysed in that the wall of said element has thereon or contained therein one or more catalytic materials. Catalytic materials may be present on the inlet side of the element wall alone, the outlet side alone, both the inlet and outlet sides, or the wall itself may consist, all, or in part, of the catalytic material. This invention includes the use of one or more layers of catalytic material on the inlet and/or outlet walls of the element.

### Washcoat/s on Substrate:

The first substrate is coated with the first three-way catalyst and the second substrate is coated with the second three-way catalyst.

Preferably, the first three-way catalyst covers 50 to 100% of length of the first substrate. More preferably, the first three-way catalyst covers 70 to 100% of the length of the first substrate and even more preferably, the first three-way catalyst covers 90 to 100% of length of the first substrate. Most preferably, the first three-way catalyst covers the whole length or the whole accessible surface area of the substrate.

Preferably, the second three-way catalyst covers 50 to 100% of length of the second substrate. More preferably, the second three-way catalyst covers 70 to 100% of the length of the second substrate and even more preferably, the second three-way catalyst covers 90 to 100% of length of the second substrate. Most preferably, the second three-way catalyst covers the whole length or the whole accessible surface area of the substrate.

The term “accessible surface” refers to the surface of the substrate which can be covered with the conventional coating techniques used in the field of catalyst preparation like impregnation techniques

### First Three-Way Conversion (TWC) Catalyst

The first three-way catalyst is deposited at least on a part of a first substrate. Preferably, the first three-way catalyst covers 50 to 100% of length of the first substrate. More preferably, the first three-way catalyst covers 70 to 100% of the length of the first substrate and even more preferably, the first three-way catalyst covers 90 to 100% of length of the first substrate. Most preferably, the first three-way catalyst covers the whole length or the whole accessible surface area of the substrate.

The first three-way catalyst comprises platinum supported on alumina, ceria-zirconia mixed oxide, ceria-alumina composite, or any combination thereof, palladium supported on alumina, ceria-zirconia mixed oxide, ceria-alumina composite, or any combination thereof, and rhodium supported on alumina, ceria-zirconia mixed oxide, ceria-alumina composite, or any combination thereof.

Preferably, the total washcoat loading of the first three-way catalyst is 1.0 to 10 g/in³. More preferably, the total washcoat loading of the first three-way catalyst is 2.0 to 7.0 g/in³. Even more preferably, the total washcoat loading of the first three-way catalyst is 2.5. to 4.5 g/in³.

Preferably, the total platinum group metal (PGM) loading of the first three-way catalyst is 10 to 200 g/ft³. More preferably, the total platinum group metal (PGM) loading of the first three-way catalyst is 50 to 175 g/ft³. Even more preferably, the total platinum group metal (PGM) loading of the first three-way catalyst is 100 to 130 g/ft³.

Preferably, the first three-way catalyst is a single layer catalyst or two-layered catalyst or two-layered catalyst with a zoned configuration.

In a preferred embodiment, the first three-way catalyst is a two-layered catalyst, comprising a first layer deposited at least on a part of the first substrate and a second layer deposited at least on a part of first layer or on a part of the first substrate or both, wherein the first layer comprises platinum supported on alumina, ceria-zirconia mixed oxide, ceria-alumina composite, or any combination thereof; and palladium supported on alumina, ceria-zirconia mixed oxide, ceria-alumina composite, or any combination thereof, wherein the second layer comprises rhodium supported on alumina, ceria-zirconia mixed oxide, ceria-alumina composite, or any combination thereof.

In a more preferred embodiment, the first three-way catalyst is a two-layered catalyst, comprising a first layer deposited at least on a part of the first substrate and a second layer deposited at least on a part of first layer or on a part of the first substrate or both, wherein the first layer comprises platinum supported on the ceria-alumina composite, and palladium supported on the ceria-zirconia mixed oxide, wherein the second layer comprises rhodium supported on the ceria-alumina composite and the ceria-zirconia mixed oxide.

Preferably, the washcoat loading of the first layer is 0.5 to 7.0 g/in³ and the washcoat loading of the second layer is 0.5 to 3.0 g/in³. More preferably, the washcoat loading of the first layer is 1.0 to 3.0 g/in³ and the washcoat loading of the second layer is 0.5 to 2.0 g/in³. Even more preferably, the washcoat loading of the first layer is 2.0 to 3.0 g/in³ and the washcoat loading of the second layer is 0.5 to 1.5 g/in³.

In a most preferred embodiment, the first three-way catalyst is a two-layered catalyst, wherein
the total washcoat loading of the first three-way catalyst is 1.0 to 10 g/in³,
wherein the washcoat loading of the first layer is 0.5 to 7.0 g/in³,
wherein the washcoat loading of the second layer is 0.5 to 3.0 g/in³,
wherein the total PGM loading is 10 to 200 g/ft³,
wherein the first layer comprises 5.0 to 100 g/ft³ Pt deposited onto the ceria-alumina composite and 5.0 to 100 g/ft³ Pd deposited onto the ceria-zirconia mixed oxide,
wherein the second layer comprises 0.5 to 5 g/ft³ Rh deposited onto a refractory ceria-alumina composite, and a ceria-zirconia mixed oxide.

In even most preferred embodiment, the first three-way catalyst is a two-layered catalyst, wherein
the total washcoat loading of the first three-way catalyst is 2.5 to 4.5 g/in³,
wherein the washcoat loading of the first layer is 2.0 to 3.0 g/in³,
wherein the washcoat loading of the second layer is 0.5 to 1.5 g/in³.
the total PGM loading is 101 to 153 g/ft³,
wherein the first layer comprises 50 to 75 g/ft³ Pt deposited onto the ceria-alumina composite and 50 to 75 g/ft³ Pd deposited onto the ceria-zirconia mixed oxide,
wherein the second layer comprises 1 to 3 g/ft³ Rh deposited onto a refractory ceria-alumina composite, and a ceria-zirconia mixed oxide.
In another preferred embodiment, the first three-way catalyst is a two layered catalyst comprising a first layer and a second layer,
   wherein the first layer comprises a first zone and a second zone,
   wherein the first zone comprises palladium supported on alumina, ceria-zirconia mixed oxide, ceria-alumina composite, or any combination thereof,
   wherein the second zone comprises platinum supported on alumina, ceria-zirconia mixed oxide, ceria-alumina composite, or any combination thereof, and palladium supported on alumina, ceria-zirconia mixed oxide, ceria-alumina composite, or any combination thereof
wherein the second layer is deposited at least on a part of the first layer, wherein the second layer comprises rhodium supported on alumina, ceria-zirconia mixed oxide, ceria-alumina composite, or any combination thereof.
In another more preferred embodiment, the first three-way catalyst is a two layered catalyst comprising a first layer and a second layer,
   wherein the first layer comprises a first zone and a second zone,
   wherein the first zone and the second zone 100% of the substrate length,
   wherein the first zone comprises 100 to 200 g/ft³ palladium supported on alumina and ceria-zirconia mixed oxide,
   wherein the second zone comprises 25 to 100 g/ft³ platinum supported on ceria-zirconia mixed oxide and ceria-alumina composite, and 5.0 to 25 g/ft³ palladium supported on ceria-zirconia mixed oxide and ceria-alumina composite,
wherein the second layer is deposited at least on a part of the first layer, wherein the second layer comprises 1.0 to 10 g/ft³ rhodium supported on ceria-zirconia mixed oxide and ceria-alumina composite,
wherein the total washcoat loading of the first three-way catalyst is 1.0 to 10 g/in³ and the total PGM loading is 10 to 200 g/ft³,
wherein the washcoat loading of the first zone is 0.25 to 4.0 g/in³,
wherein the washcoat loading of the second zone is 0.25 to 4.0 g/in³,
wherein the washcoat loading of the second layer is 0.25 to 2.0 g/in³,
wherein 70% of the total platinum is deposited onto the refractory ceria-alumina composite, and 30% of the total platinum is deposited onto the ceria-zirconia mixed oxide.

In the context of the present invention the term “first zone” is interchangeably used for “inlet zone” or “front zone” and the term “second zone” is interchangeably used for “outlet zone” or “rear zone”. The terms “first zone” and “second zone” also describe the relative positioning of the catalytic article in flow direction, respectively the relative positing of the catalytic article when placed in an exhaust gas treatment system. The first zone would be positioned upstream, whereas the second zone would be positioned downstream. The first zone covers at least some portion of the substrate from the inlet of the substrate, whereas the second zone covers at least some portion of the substrate from the outlet of the substrate. The inlet of the substrate is a first end which is capable to receive the flow of an engine exhaust gas stream from an engine (flow-in end portion), whereas the outlet of the substrate is a second end from which a treated exhaust gas stream exit (flow-out end portion).

Preferably, the first zone and the second zone together cover 50 to 100% of length of the substrate. More preferably, the first and second zone together cover 90 to 100% of the length of the substrate and even more preferably, the first and the second zone together cover the whole length or the whole accessible surface area of the substrate.

The term “accessible surface” refers to the surface of the substrate which can be covered with the conventional coating techniques used in the field of catalyst preparation like impregnation techniques.

Preferably, the first zone covers 10 to 90% of the entire substrate length from an inlet and the second zone covers 90 to 10% of the entire substrate length from an outlet, while the first zone and the second zone together cover 20 to 100% of the length of the substrate.

More preferably, the first zone covers 20 to 80% of the entire substrate length from the inlet and the second zone covers 80 to 20% of the entire substrate length from the outlet, while the first zone and the second zone together cover 40 to 100% of the length of the substrate.

Even more preferably, the first zone covers 30 to 70% of the entire substrate length from the inlet and the second zone covers 70 to 30% of the entire substrate length from the outlet, while the first zone and the second zone together cover 60 to 100% of the length of the substrate.

Even most preferably, the first zone covers 40 to 50% of the entire substrate length from the inlet and the second zone covers 50 to 40% of the entire substrate length from the outlet, while the first zone and the second zone together cover 80 to 100% of the length of the substrate.

Preferably, the total amount of platinum supported on alumina, ceria-zirconia mixed oxide, ceria-alumina composite, or any combination thereof in the first three-way catalyst is in the range of 0.05 to 3.0 wt. %, based on the total weight of the first three-way catalyst.

More preferably, the total amount of platinum supported on alumina, ceria-zirconia mixed oxide, ceria-alumina composite, or any combination thereof in the first three-way catalyst is in the range of 0.1 to 1.0 wt. %, based on the total weight of the first three-way catalyst.

Preferably, the total amount of palladium supported on alumina, ceria-zirconia mixed oxide, ceria-alumina composite, or any combination thereof in the first three-way catalyst is in the range of 0.05 to 5.0 wt. %, based on the total weight of the first three-way catalyst.

More preferably, the total amount of palladium supported on alumina, ceria-zirconia mixed oxide, ceria-alumina composite, or any combination thereof in the first three-way catalyst is in the range of 0.1 to 2.0 wt. %, based on the total weight of the first three-way catalyst.

Preferably, the amount of rhodium supported on alumina, ceria-zirconia mixed oxide, ceria-alumina composite, or any combination thereof in the first three-way catalyst is in the range of 0.001 to 1.0 wt. %, based on the total weight of the first three-way catalyst.

More preferably, the amount of rhodium supported on alumina, ceria-zirconia mixed oxide, ceria-alumina composite, or any combination thereof in the first three-way catalyst is in the range of 0.005 to 0.5 wt. %, based on the total weight of the first three-way catalyst.

### Ceria-Alumina Composite:

Preferably, the amount of the ceria-alumina composite present in the first three-way catalyst is in the range of 5.0 to 80 wt. %, based on the total weight of the first three-way catalyst. More preferably, the amount of the ceria-alumina composite present in the first three-way catalyst is in the range of 10 to 60 wt. %, based on the total weight of the first three-way catalyst. Most preferably, the amount of the ceria-alumina composite present in the first three-way catalyst is in the range of 15 to 60 wt. %, based on the total weight of the first three-way catalyst.

### Ceria-Zirconia Mixed Oxide (CZO):

Preferably, the amount of the ceria-zirconia mixed oxide present in the first three-way catalyst is 20 to 80 wt. %, based on the total weight of the first three-way catalyst. More preferably, the amount of the ceria-zirconia mixed oxide present in the first three-way catalyst is 25 to 75 wt. %, based on the total weight of the first three-way catalyst. Most preferably, the amount of the ceria-zirconia mixed oxide present in the first three-way catalyst is 30 to 75 wt. %, based on the total weight of the first three-way catalyst.

### Alumina:

Preferably, the amount of alumina present in the first three-way catalyst is in the range of 5.0 to 70 wt. %, based on the total weight of the first three-way catalyst. More preferably, the amount of alumina present in the first three-way catalyst is in the range of 10 to 60 wt. %, based on the total weight of the first three-way catalyst. Most preferably, the amount of alumina present in the first three-way catalyst is in the range of 15 to 60 wt. %, based on the total weight of the first three-way catalyst.

### Second Three-Way Conversion (TWC) Catalyst

The second three-way catalyst deposited at least on a part of a second substrate. The second three-way catalyst preferably covers 50 to 100% of length of the second substrate. More preferably, the second three-way catalyst covers 70 to 100% of the length of the second substrate and even more preferably, the second three-way catalyst covers 90 to 100% of length of the second substrate. Most preferably, the second three-way catalyst covers the whole length or the whole accessible surface area of the substrate.

The second three-way catalyst comprises platinum supported on alumina, ceria-zirconia mixed oxide, ceria-alumina composite, or any combination thereof.

Preferably, the second three-way catalyst additionally comprises rhodium supported on alumina, ceria-zirconia mixed oxide, ceria-alumina composite, or any combination thereof.

In a preferred embodiment, the second three-way catalyst is essentially free of palladium. The term “essentially free of palladium” means no palladium is added in the second three-way catalyst. It may be present as an impurity in an amount of less than 0.001 wt. %. In another preferred embodiment, the second three-way catalyst comprises palladium supported on alumina, ceria-zirconia mixed oxide, ceria-alumina composite, or any combination thereof.

Preferably, the backpressure loss of the second three-way catalyst is less than 38%. More preferably, the backpressure contribution of the second three-way catalyst is less than 35%. Most preferably the backpressure contribution of the second three-way catalyst is less than 32%. Preferably, the washcoat loading is the main means to achieve the desired backpressure.

Preferably, the second three-way catalyst is a single-coat, monolayer catalyst deposited on the second substrate with a total washcoat loading in the range of 1.5 to 3.2 g/in³. More preferably, the total washcoat loading in the second three-way catalyst in the range of 2.0 to 3.0 g/in³. Most preferably, the total washcoat loading in the second three-way catalyst in the range of 2.5 to 2.8 g/in³.

Preferably, the total amount of platinum supported on alumina, ceria-zirconia mixed oxide, ceria-alumina composite, or any combination thereof in the second three-way catalyst is in the range of 0.01 to 1.0 wt. %, based on the total weight of the second three-way catalyst.

More preferably, the total amount of platinum supported on alumina, ceria-zirconia mixed oxide, ceria-alumina composite, or any combination thereof in the second three-way catalyst is in the range of 0.05 to 0.5 wt. %, based on the total weight of the first three-way catalyst.

Preferably, the total amount of palladium supported on alumina, ceria-zirconia mixed oxide, ceria-alumina composite, or any combination thereof in the first three-way catalyst is in the range of 0.01 to 1.0 wt. %, based on the total weight of the first three-way catalyst.

More preferably, the total amount of palladium supported on alumina, ceria-zirconia mixed oxide, ceria-alumina composite, or any combination thereof in the first three-way catalyst is in the range of 0.01 to 1.0 wt. %, based on the total weight of the first three-way catalyst.

Preferably, the amount of rhodium supported on alumina, ceria-zirconia mixed oxide, ceria-alumina composite, or any combination thereof in the first three-way catalyst is in the range of 0.001 to 0.5 wt. %, based on the total weight of the first three-way catalyst.

More preferably, the amount of rhodium supported on alumina, ceria-zirconia mixed oxide, ceria-alumina composite, or any combination thereof in the first three-way catalyst is in the range of 0.002 to 0.1 wt. %, based on the total weight of the first three-way catalyst.

### Ceria-Alumina Composite:

Preferably, the amount of the ceria-alumina composite present in the second three-way catalyst is in the range of 5.0 to 80 wt. %, based on the total weight of the second three-way catalyst. More preferably, the amount of the ceria-alumina composite present in the second three-way catalyst is in the range of 10 to 60 wt. %, based on the total weight of the second three-way catalyst. Most preferably, the amount of the ceria-alumina composite present in the second three-way catalyst is in the range of 15 to 60 wt. %, based on the total weight of the second three-way catalyst.

### Ceria-Zirconia Mixed Oxide (CZO):

Preferably, the amount of the ceria-zirconia mixed oxide present in the second three-way catalyst is 20 to 80 wt. %, based on the total weight of the second three-way catalyst. More preferably, the amount of the ceria-zirconia mixed oxide present in the second three-way catalyst is 25 to 75 wt. %, based on the total weight of the second three-way catalyst. Most preferably, the amount of the ceria-zirconia mixed oxide present in the second three-way catalyst is 30 to 75 wt. %, based on the total weight of the second three-way catalyst.

### Alumina:

Preferably, the amount of alumina present in the second three-way catalyst is in the range of 5.0 to 70 wt. %, based on the total weight of the second three-way catalyst. More preferably, the amount of alumina present in the second three-way catalyst is in the range of 10 to 60 wt. %, based on the total weight of the second three-way catalyst. Most preferably, the amount of alumina present in the second three-way catalyst is in the range of 15 to 60 wt. %, based on the total weight of the second three-way catalyst.

### Preparation of TWC:

The first or second three-way catalyst is prepared by depositing platinum group metal/s at least on a part of a first or second substrate.

Preferably, the platinum group metal deposition involves forming a slurry of platinum group metal/s and support material followed by coating the slurry as a washcoat on the substrate.

The step of preparing the slurry comprises a technique selected from incipient wetness impregnation, incipient wetness co-impregnation, and post-addition.

Incipient wetness impregnation techniques, also called capillary impregnation or dry impregnation are commonly used for the synthesis of heterogeneous materials, i.e., catalysts.

Typically, a metal precursor is dissolved in an aqueous or organic solution and then the metal-containing solution is added to a catalyst support containing the same pore volume as the volume of the solution that was added. Capillary action draws the solution into the pores of the support. Solution added in excess of the support pore volume causes the solution transport to change from a capillary action process to a diffusion process, which is much slower. The catalyst is dried and calcined to remove the volatile components within the solution, depositing the metal on the surface of the catalyst support. The concentration profile of the impregnated material depends on the mass transfer conditions within the pores during impregnation and drying.

The support particles are typically dry enough to absorb substantially all of the solution to form a moist solid. Aqueous solutions of water-soluble compounds or complexes of the active metal are typically utilized, such as rhodium chloride, rhodium nitrate (e.g., Rh (NO) 3 and salts thereof), rhodium acetate, or combinations thereof where rhodium is the active metal; palladium nitrate, palladium tetra amine nitrate, palladium acetate, or combinations thereof where palladium is the active metal; and platinum nitrate, platinum acetate, or combination thereof where platinum is the active metal. Following treatment of the support particles with the active metal solution, the particles are dried, such as by heat treating the particles at elevated temperature (e.g., 100-150 °C) for a period of time (e.g., 1-3 hours), and then calcined to convert the active metal to a more catalytically active form. An exemplary calcination process involves heat treatment in air at a temperature of about 400-550 °C for 10 min to 3 hours. The above process can be repeated as needed to reach the desired level of active metal impregnation.

### Substrate Coating:

The above-noted three-way conversion catalysts are typically prepared in the form of catalyst particles as noted above. These catalyst particles are mixed with water to form a slurry for purposes of coating a catalyst substrate, such as a honeycomb-type substrate. In addition to the catalyst particles, the slurry may optionally contain a binder in the form of alumina, silica, zirconium acetate, colloidal zirconia, or zirconium hydroxide, associative thickeners, and/or surfactants (including anionic, cationic, non-ionic, or amphoteric surfactants). Other exemplary binders include boehmite, gamma-alumina, or delta/theta alumina, as well as silica sol. When present, the binder is typically used in an amount of about 1.0-5.0 wt. % of the total washcoat loading. Addition of acidic or basic species to the slurry is carried out to adjust the pH accordingly. For example, in some embodiments, the pH of the slurry is adjusted by the addition of ammonium hydroxide, aqueous nitric acid, or acetic acid. A typical pH range for the slurry is about 3.0 to 12. The slurry can be milled to reduce the particle size and enhance particle mixing. The milling is accomplished in a ball mill, continuous mill, or other similar equipment, and the solids content of the slurry may be, e.g., about 20-60 wt. %, more particularly about 20-40 wt. %. In one embodiment, the post-milling slurry is characterized by a D₉₀ particle size of about 10 to about 40 microns, preferably 10 to about 30 microns, more preferably about 10 to about 15 microns. The D₉₀ is determined using a dedicated particle size analyzer. The equipment employed in this example uses laser diffraction to measure particle sizes in small volume slurry. The D₉₀, typically with units of microns, means 90% of the particles by number have a diameter less than that value.

The slurry is coated on the catalyst substrate using any washcoat technique known in the art. E.g., the catalyst substrate is dipped one or more times in the slurry or otherwise coated with the slurry. Thereafter, the coated substrate is dried at an elevated temperature (e.g., 100-150 °C) for a period of time (e.g., 10 min-3.0 hours) and then calcined by heating, e.g., at 400-700 °C, typically for about 10 minutes to about 3 hours. Following drying and calcining, the final washcoat coating layer is viewed as essentially solvent-free.

After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

The coated substrate can be aged, by subjecting the coated substrate to heat treatment. E.g., aging is done at a temperature of about 850 °C to about 1050 °C in the presence of steam under gasoline engine exhaust conditions for 50-300 hours. Aged catalyst articles are thus provided according to present invention. The effective support material such as ceria-alumina composites maintains a high percentage (e.g., about 50-100%) of their pore volumes upon aging (e.g., at about 850 °C to about 1050 °C in the presence of steam for about 50-300 hours aging).

Preferably, the first three-way catalyst is prepared by depositing platinum group metal/s at least on a part of a first or second substrate, wherein the platinum group metals comprises platinum supported on alumina, ceria-zirconia mixed oxide, ceria-alumina composite, or any combination thereof, palladium supported on alumina, ceria-zirconia mixed oxide, ceria-alumina composite, or any combination thereof, and rhodium supported on alumina, ceria-zirconia mixed oxide, ceria-alumina composite, or any combination thereof.

Preferably, the second three-way catalyst is prepared by depositing platinum and optionally, rhodium at least on a part of the second substrate, wherein platinum is supported on alumina, ceria-zirconia mixed oxide, ceria-alumina composite, or any combination thereof, wherein rhodium is supported on alumina, ceria-zirconia mixed oxide, ceria-alumina composite, or any combination thereof.

The present invention is further illustrated by the following set of embodiments and combinations of embodiments resulting from the dependencies and back-references as indicated. In particular, it is noted that in each instance where a range of embodiments is mentioned, for example in the context of a term such as “The exhaust aftertreatment system of any one of embodiments 1 to 4”, every embodiment in this range is meant to be explicitly disclosed for the skilled person, i.e. the wording of this term is to be understood by the skilled person as being synonymous to “The exhaust aftertreatment system of any one of embodiments 1, 2, 3 and 4”. Further, it is explicitly noted that the following set of embodiments represents a suitably structured part of the general description directed to preferred aspects of the present invention, and, thus, suitably supports, but does not represent the claims of the present invention.

### Embodiment 1

The exhaust aftertreatment system comprising:
a. a first three-way catalyst deposited at least on a part of a first substrate; and
b. a second three-way catalyst deposited at least on a part of a second substrate,
wherein the first three-way catalyst comprises:
   i) platinum supported on alumina, ceria-zirconia mixed oxide, ceria-alumina composite, or any combination thereof,
   ii) palladium supported on alumina, ceria-zirconia mixed oxide, ceria-alumina composite, or any combination thereof, and
   iii) rhodium supported on alumina, ceria-zirconia mixed oxide, ceria-alumina composite, or any combination thereof,
wherein the second three-way catalyst comprises platinum supported on alumina, ceria-zirconia mixed oxide, ceria-alumina composite, or any combination thereof.

### Embodiment 2

The exhaust aftertreatment system according to embodiment 1, wherein the second three-way catalyst comprises rhodium supported on alumina, ceria-zirconia mixed oxide, ceria-alumina composite, or any combination thereof.

### Embodiment 3

The exhaust aftertreatment system according to any of embodiments 1 to 2, wherein the second three-way catalyst is essentially free of palladium.

### Embodiment 4

The exhaust aftertreatment system according to any of embodiments 1 to 2, wherein the second three-way catalyst comprises palladium supported on alumina, ceria-zirconia mixed oxide, ceria-alumina composite, or any combination thereof.

### Embodiment 5

The exhaust aftertreatment system according to embodiment 1, wherein the weight ratio of platinum supported on alumina, ceria-zirconia mixed oxide, ceria-alumina composite, or any combination thereof in the first three-way catalyst to the platinum supported on alumina, ceria-zirconia mixed oxide, ceria-alumina composite, or any combination thereof in the second three-way catalyst is in the range of 2:1 to 20:1, preferably in the range of 2.5:1 to 12:1.

### Embodiment 6

The exhaust aftertreatment system according to embodiment 2, wherein the weight ratio of the rhodium supported on alumina, ceria-zirconia mixed oxide, ceria-alumina composite, or any combination thereof in the first three-way catalyst to the rhodium supported on alumina, ceria-zirconia mixed oxide, ceria-alumina composite, or any combination thereof in the second three-way catalyst is in the range of 1:3 to 50:1, preferably in the range of 1:1 to 50:1, more preferably in the range of 1:2 to 20:1, more preferably in the range of 1:1 to 20:1, more preferably in the range of 1:1.5 to 4:1, and more preferably in the range of 1:1 to 4:1.

### Embodiment 7

The exhaust aftertreatment system according to any of embodiments 1 to 6, wherein the weight ratio of the total amount of platinum, palladium and rhodium, each supported on alumina, ceria-zirconia mixed oxide, ceria-alumina composite, or any combination thereof in the first three-way catalyst to the total amount of platinum, optionally with rhodium and palladium, each supported on alumina, ceria-zirconia mixed oxide, ceria-alumina composite, or any combination thereof in the second three-way catalyst is in the range of 4:1 to 20:1.

### Embodiment 8

The exhaust aftertreatment system according to any of embodiments 1 to 7, wherein the system characterized in that the backpressure contribution of the second three-way catalyst is less than 38%, preferably less than 35%, and more preferably less than 32%.

### Embodiment 9

The exhaust aftertreatment system according to any of embodiments 1 to 8, wherein the second three-way catalyst is a single layered catalyst deposited on the second substrate with a total washcoat loading in the range of 1.5 to 3.2 g/in³, preferably in the range of 2.0 to 3.0 g/in³, and more preferably in the range of 2.5 to 2.8 g/in³.

### Embodiment 10

The exhaust aftertreatment system according to any of embodiments 1 to 9, wherein the first three-way catalyst is a two layered catalyst comprising a first layer deposited at least on a part of the first substrate and a second layer deposited at least on a part of first layer or on a part of the first substrate or both,
wherein the first layer comprises platinum supported on alumina, ceria-zirconia mixed oxide, ceria-alumina composite, or any combination thereof; and palladium supported on alumina, ceria-zirconia mixed oxide, ceria-alumina composite, or any combination thereof, wherein the second layer comprises rhodium supported on alumina, ceria-zirconia mixed oxide, ceria-alumina composite, or any combination thereof.

### Embodiment 11

The exhaust aftertreatment system according to any of claims 1 to 10, wherein the first three-way catalyst is a two layered catalyst comprising a first layer and a second layer,
wherein the first layer comprises a first zone and a second zone, wherein the first zone covers 10 to 90% of the entire substrate length from an inlet and the second zone covers 10 to 90% of the entire substrate length from an outlet,
wherein the first zone comprises palladium supported on alumina, ceria-zirconia mixed oxide, ceria-alumina composite, or any combination thereof,
wherein the second zone comprises platinum supported on alumina, ceria-zirconia mixed oxide, ceria-alumina composite, or any combination thereof, and palladium supported on alumina, ceria-zirconia mixed oxide, ceria-alumina composite, or any combination thereof
wherein the second layer is deposited at least on a part of the first layer, wherein the second layer comprises rhodium supported on alumina, ceria-zirconia mixed oxide, ceria-alumina composite, or any combination thereof.

### Embodiment 12

The exhaust aftertreatment system according to any of embodiments 1 to 11, wherein the total ceria-zirconia mixed oxide loading in the first three-way catalyst is higher than the total ceria-zirconia mixed oxide loading in the second three-way catalyst.

### Embodiment 13

The exhaust aftertreatment system according to any of embodiments 1 to 12, wherein the total amount of platinum supported on alumina, ceria-zirconia mixed oxide, ceria-alumina composite, or any combination thereof in the first three-way catalyst and the second three-way catalyst is in the range of 0.02 to 3.0 wt. %, preferably in the range of 0.03 to 2.5 wt %, based on the total weight of the first three-way catalyst and the second three-way catalyst.

### Embodiment 14

The exhaust aftertreatment system according to any of embodiments 1 to 13, wherein the total amount of palladium supported on alumina, ceria-zirconia mixed oxide, ceria-alumina composite, or any combination thereof in the first three-way catalyst and the second three-way catalyst is in the range of 0.02 to 3.0 wt. %, and preferably in the range of 0.02 to 2.0 wt %, based on the total weight of the first three-way catalyst and the second three-way catalyst.

### Embodiment 15

The exhaust aftertreatment system according to any of embodiments 1 to 13, wherein the total amount of rhodium supported on alumina, ceria-zirconia mixed oxide, ceria-alumina composite, or any combination thereof in the first three-way catalyst and the second three-way catalyst is in the range of 0.01 to 2.0 wt. %, preferably in the range of 0.01 to 1.5 wt. %, and more preferably in the range of 0.01 to 1.0 wt. %, based on the total weight of the first three-way catalyst and the second three-way catalyst.

### Embodiment 16

The exhaust aftertreatment system according to any of embodiments 1 to 15, wherein the substrate is selected from a ceramic substrate, a metal substrate, a ceramic foam substrate, a polymer foam substrate, or a woven fiber substrate.

### Embodiment 17

The exhaust aftertreatment system according to any of embodiments 1 to 16, wherein the total amount of the ceria-zirconia mixed oxide present in the first three-way catalyst and the second three-way catalyst is in the range of 20 to 80 wt. %, preferably in the range of 25 to 75 wt. %, more preferably in the range of 30 to 75 wt. %, and more preferably in the range of 40 to 60 wt. %, based on the total weight of the first three-way catalyst and the second three-way catalyst.

### Embodiment 18

The exhaust aftertreatment system according to any of embodiments 1 to 17, wherein the total amount of the alumina present in the first three-way catalyst and the second three-way catalyst is in the range of 5.0 to 70 wt. %, preferably in the range of 5.0 to 20 wt. %, based on the total weight of the first three-way catalyst and the second three-way catalyst; or wherein the amount of the alumina present in the first three-way catalyst and the second three-way catalyst is in the range of 10 to 60 wt. %, preferably in the range of 15 to 60 wt. %, based on the total weight of the first three-way catalyst and the second three-way catalyst.

### Embodiment 19

The exhaust aftertreatment system according to any of embodiments 1 to 18, wherein the alumina present in the first three-way catalyst and the second three-way catalyst is doped with a dopant selected from barium, lanthana, zirconia, neodymian, yttria, ceria or titania,
wherein the amount of the dopant is 1.0 to 30 wt. % based on the total weight of the alumina and dopant present in the first three-way catalyst or the second three-way catalyst.

### Embodiment 20

The exhaust aftertreatment system according to any of embodiments 1 to 19, wherein alumina is selected from alumina, lanthana-alumina, titania-alumina, ceria-zirconia-alumina, zirconia-alumina, ceria-alumina, lanthana-zirconia-alumina, baria-alumina, baria-lanthana-alumina, baria-lanthana-neodymia-alumina, yttrium-alumina, or any combination thereof.

### Embodiment 21

The exhaust aftertreatment system according to any of embodiments 1 to 20, wherein the total amount of the ceria-alumina composite present in the first three-way catalyst and the second three-way catalyst is in the range of 5.0 to 80 wt. %, preferably in the range of 10 to 60 wt. %, more preferably in the range of 15 to 60 wt. %, and more preferably in the range of 15 to 40 wt. %, based on the total weight of first three-way catalyst and the second three-way catalyst.

### Embodiment 22

The exhaust aftertreatment system according to embodiment 1, wherein the system comprises:
i) an engine producing an exhaust gas stream;
ii) a first three-way catalyst deposited at least on a part of a first substrate; and
iii) a second three-way catalyst deposited at least on a part of a second substrate,
wherein the first three-way catalyst is positioned upstream from the engine and the second three-way catalyst is positioned downstream in fluid communication with the first three-way catalyst.

### Embodiment 23

The system according to any of embodiments 1 to 16 and 22, wherein the amount of the ceria-alumina composite present in the first three-way catalyst and the second three-way catalyst is in the range of 5.0 to 80 wt. %, and the amount of the ceria-zirconia mixed oxide present in the first three-way catalyst and the second three-way catalyst is 20 to 80 wt. %, based on the total weight of the first three-way catalyst and the second three-way catalyst, and wherein the amount of CeO₂ in the ceria-alumina composite present in the first three-way catalyst or the second three-way catalyst is preferably 1.0 to 60 wt. %, based on the total weight of the ceria-alumina composite in the respective catalyst, wherein CeO₂ of the ceria-zirconia mixed oxide present in the first three-way catalyst or the second three-way catalyst is present in an amount of 10 to 60 wt. %, based on the total weight of the ceria-zirconia mixed oxide present in the respective catalyst and zirconia (calculated as ZrO₂) of the ceria-zirconia mixed oxide present in the first three-way catalyst or the second three-way catalyst is present in an amount of 40 to 90 wt. %, based on the total weight of the ceria-zirconia mixed oxide present in the respective catalyst

### Embodiment 24

A method of reducing hydrocarbons, carbon monoxide, and nitrogen oxide levels in a gaseous exhaust stream, the method comprising contacting a gaseous exhaust stream with exhaust aftertreatment system according to any of embodiments 1 to 23 to reduce the levels of hydrocarbons, carbon monoxide, and nitrogen oxide in the exhaust gas.

### Embodiment 25

Use of the exhaust aftertreatment system according to any of embodiments 1 to 23 for purifying a gaseous exhaust stream comprising hydrocarbons, carbon monoxide, and nitrogen oxide.

Aspects of the presently claimed invention are more fully illustrated by the following examples, which are set forth to illustrate certain aspects of the present invention and are not to be construed as limiting thereof.

The washcoat component loadings and backpressure losses of upstream TWC-1 and downstream TWC-2 are provided in the following Table No. 1:

TABLE 1
Washcoat component loadings and backpressure losses of upstream TWC-1 and downstream TWC-2

| | Upstream TWC-1 | | | | | | Downstream TWC-2 | | | | | |
|---|---|---|---|---|---|---|---|---|---|---|---|---|
| | | | | | | BP | | | | | | BP |
| Example | Pt | Pd | Rh | CeO₂^{a} | WCL^{b} | Loss^{c} | Pt | Pd | Rh | CeO₂^{a} | WCL^{b} | Loss^{c} |
| Systems | g/ft³ | g/ft³ | g/ft³ | g/in³ | g/in³ | % | g/ft³ | g/ft³ | g/ft³ | g/in³ | g/in³ | % |
| Example 1 | 0 | 118 | 2 | 0.59 | 3.61 | 44 | 0 | 10 | 2 | 0.59 | 3.55 | 44 |
| (S1), | | | | | | | | | | | | |
| Comparative | | | | | | | | | | | | |
| Example 2 | 59 | 59 | 2 | 0.71 | 3.62 | 43 | 10 | 0 | 2 | 0.62 | 2.76 | 30 |
| (S2) | | | | | | | | | | | | |
| Example 3 | 59 | 59 | 2 | 0.71 | 3.62 | 43 | 10 | 0 | 2 | 0.95 | 2.82 | 30 |
| (S3) | | | | | | | | | | | | |
| Example 4 | 59 | 59 | 2 | 0.71 | 3.62 | 43 | 5 | 5 | 2 | 0.62 | 2.76 | 30 |
| (S4) | | | | | | | | | | | | |
| Example 5 | 29 | 87 | 4 | 0.80 | 3.57 | 45 | 0 | 10 | 2 | 0.36 | 2.82 | 34 |
| (S5), | | | | | | | | | | | | |
| Comparative | | | | | | | | | | | | |
| Example 6 | 29 | 87 | 4 | 0.80 | 3.57 | 45 | 10 | 0 | 2 | 0.62 | 2.76 | 30 |
| (S6) | | | | | | | | | | | | |

^{a}CeO₂: Total CeO₂ loading including all CeO₂ contents from ceria-zirconia mixed oxides and other washcoat components
^{b}WCL: Total washcoat loading
^{c}BP Loss: Backpressure loss

### Example 1: System 1 (S1), Comparative

S1 comprises a conventional Pd/Rh-based upstream catalyst S1-TWC-1 and a conventional Pd/Rh-based downstream catalyst S1-TWC-2. S1-TWC-1 has a bilayer washcoat structure which was coated on a monolith cordierite substrate having dimensions of 4.66″ in diameter and 3.81″ in length, a cell density of 800 cpsi (cells per square inch), and a wall thickness of 2.5 mils. The total washcoat loading is 3.61 g/in³ and the total PGM loading is 120 g/ft³ (Pt/Pd/Rh=0/118/2). The catalyst has 0.59 g/in³ ceria, and the backpressure loss is about 44%. The bottom layer comprises 118 g/ft³ Pd equally deposited onto a refractory alumina and a ceria-zirconia mixed oxide, and barium oxide. The washcoat loading of the bottom layer is 2.61 g/in³. The top layer comprises 2 g/ft³ Rh deposited onto a refractory alumina, and a ceria-zirconia mixed oxide. The washcoat loading of the top layer is 1.00 g/in³. S1-TWC-2 has the same washcoat components to S1-TWC-1, except that the total PGM loading is 12 g/ft³ (Pt/Pd/Rh=0/10/2). The downstream catalyst was coated on a monolith cordierite substrate having dimensions of 5.20″ in diameter and 3.96″ in length, a cell density of 400 cpsi, and a wall thickness of 6.5 mils.

### Example 2: System 2 (S2)

S2 comprises a Pt/Pd/Rh-based upstream catalyst S2-TWC-1 and a Pt/Rh-based downstream catalyst S2-TWC-2. S2-TWC-1 has a bilayer washcoat structure which was coated on a monolith cordierite substrate having dimensions of 4.66″ in diameter and 3.81″ in length, a cell density of 800 cpsi, and a wall thickness of 2.5 mils. The total washcoat loading is 3.62 g/in³ and the total PGM loading is 120 g/ft³ (Pt/Pd/Rh=59/59/2). The catalyst has 0.71 g/in³ ceria, and the backpressure loss is about 43%. The bottom layer comprises 59 g/ft³ Pt deposited onto a refractory ceria-alumina composite, 59 g/ft³ Pd deposited onto a ceria-zirconia mixed oxide, and barium oxide. The washcoat loading of the bottom layer is 2.62 g/in³. The top layer comprises 2 g/ft³ Rh deposited onto a refractory ceria-alumina composite, and a ceria-zirconia mixed oxide. The washcoat loading of the top layer is 1.00 g/in³. S2-TWC-2 has a single-coat, monolayer washcoat structure which was coated on a monolith cordierite substrate having dimensions of 5.20″ in diameter and 3.96″ in length, a cell density of 400 cpsi, and a wall thickness of 6.5 mils. The total washcoat loading is 2.76 g/in³ and the total PGM loading is 12 g/ft³ (Pt/Pd/Rh=10/0/2). The catalyst has 0.62 g/in³ ceria, and the backpressure loss is about 30%. The monolayer washcoat comprises 10 g/ft³ Pt, 2 g/ft³ Rh, a refractory ceria-alumina composite, a ceria-zirconia mixed oxide, and barium oxide. All Pt and 50% Rh were deposited onto the refractory ceria-alumina composite, and the remaining 50% Rh was deposited onto the ceria-zirconia mixed oxide.

Example 3: System 3 (S3): S3 comprises a Pt/Pd/Rh-based upstream catalyst S3-TWC-1 and a Pt/Rh-based downstream catalyst S3-TWC-2. S3-TWC-1 is the same to S2-TWC-1. S3-TWC-2 has a single-coat, monolayer washcoat structure which was coated on a monolith cordierite substrate having dimensions of 5.20″ in diameter and 3.96″ in length, a cell density of 400 cpsi, and a wall thickness of 6.5 mils. The total washcoat loading is 2.82 g/in³ and the total PGM loading is 12 g/ft³ (Pt/Pd/Rh=10/0/2). The catalyst has 0.95 g/in³ ceria, and the backpressure loss is about 30%. The monolayer washcoat comprises 10 g/ft³ Pt, 2 g/ft³ Rh, a refractory ceria-alumina composite, a ceria-zirconia mixed oxide, and barium oxide. 50% Pt and all Rh were deposited onto the refractory ceria-alumina composite, and the remaining 50% Pt was deposited onto the ceria-zirconia mixed oxide.

Example 4: System 4 (S4): S4 comprises a Pt/Pd/Rh-based upstream catalyst S4-TWC-1 and a Pt/Pd/Rh-based downstream catalyst S4-TWC-2. S4-TWC-1 is the same to S2-TWC-1. S4-TWC-2 has a single-coat, monolayer washcoat structure which was coated on a monolith cordierite substrate having dimensions of 5.20″ in diameter and 3.96″ in length, a cell density of 400 cpsi, and a wall thickness of 6.5 mils. The total washcoat loading is 2.76 g/in³ and the total PGM loading is 12 g/ft³ (Pt/Pd/Rh=5/5/2). The catalyst has 0.62 g/in³ ceria, and the backpressure loss is about 30%. The monolayer washcoat comprises 5 g/ft³ Pt, 5 g/ft³ Pd, 2 g/ft³ Rh, a refractory ceria-alumina composite, a ceria-zirconia mixed oxide, and barium oxide. All Pt and Rh were deposited onto the refractory ceria-alumina composite, and all Pd was deposited onto the ceria-zirconia mixed oxide.

Example 5: System 5 (S5), Comparative: S5 comprises a Pt/Pd/Rh-based upstream catalyst S5-TWC-1 and a Pd/Rh-based downstream catalyst S5-TWC-2. S5-TWC-1 has a zoned bilayer washcoat structure with an inlet bottom zone, an outlet bottom zone (each zone covering about 50% of the substrate length), and a top layer covering 100% of the substrate length. The catalyst was coated on a monolith cordierite substrate having dimensions of 4.66″ in diameter and 3.81″ in length, a cell density of 800 cpsi, and a wall thickness of 2.5 mils. The total washcoat loading is 3.57 g/in³ and the total PGM loading is 120 g/ft³ (Pt/Pd/Rh=29/87/4). The catalyst has 0.80 g/in³ ceria, and the backpressure loss is about 45%. The inlet bottom zone comprises 156.6 g/ft³ Pd equally deposited onto a refractory alumina composite and a ceria-zirconia mixed oxide, and barium oxide. The washcoat loading of the inlet bottom zone is 2.56 g/in³. The outlet bottom zone comprises 58 g/ft³ Pt, 17.4 g/ft³ Pd, a refractory ceria-alumina composite, a ceria-zirconia mixed oxide, and barium oxide. 70% Pt was deposited onto the refractory ceria-alumina composite, and 30% Pt and all Pd was deposited onto the ceria-zirconia mixed oxide. The washcoat loading of the outlet bottom zone is 2.58 g/in³. The top layer comprises 4 g/ft³ Rh deposited onto a refractory ceria-alumina composite, and a ceria-zirconia mixed oxide. The washcoat loading of the top layer is 1.00 g/in³. S5-TWC-2 has a monolayer washcoat structure which was coated on a monolith cordierite substrate having dimensions of 5.20″ in diameter and 3.96″ in length, a cell density of 400 cpsi, and a wall thickness of 6.5 mils. The total washcoat loading is 2.82 g/in³ and the total PGM loading is 12 g/ft³ (Pt/Pd/Rh=0/10/2). The catalyst has 0.32 g/in³ ceria, and the backpressure loss is about 34%. The monolayer washcoat comprises 10 g/ft³ Pd deposited onto a ceria-zirconia mixed oxide, 2 g/ft³ Rh deposited onto a refractory alumina composite, and barium oxide.

Example 6: System 6 (S6): S6 comprises a Pt/Pd/Rh-based upstream catalyst S6-TWC-1 and a Pd/Rh-based downstream catalyst S6-TWC-2. S6-TWC-1 is the same to S5-TWC-1 and S6-TWC-2 is the same to S2-TWC-2.

### Example 7: Measurement of Backpressure Loss

The backpressure loss, or the contribution of the washcoat to the backpressure loss, was measured on a SuperFlow SF-1020 Flowbench at ambient temperature. The backpressures of the bare substrate (BP_{sub}) and the coated monolith catalyst (BP_{cat}) were collected at a flow rate of 294 cfm (cubic feet per minute). The backpressure loss of the coated monolith catalyst was calculated as follows:

Backpressure Loss=(BP_{cat}−BP_{sub})/BP_{cat}×100%

### Example 8: Engine Aging and Vehicle Testing

The example systems 1-6 were mounted in steel converter cans and aged in an exhaust pipeline of a gasoline engine which was operated under exothermic 4-mode aging cycles. The duration of the aging is 100 hours at a maximum bed temperature of about 985 °C on the upstream catalysts. The aged catalytic converters were tested on two test vehicles which were operated on the US FTP-75 drive cycle following the certified procedures and tolerances. The first test vehicle was certified on the US EPA ULEV70 (Ultra Low Emissions Vehicle) emissions standards. The second vehicle was certified on the US EPA SULEV30 (Super Ultralow Emissions Vehicle) emissions standards and calibrated with frequent fuel-cut events.

The result for FTP-75 Tailpipe bag emission data for systems S1-S4 is provided in the following Table No. 2:

TABLE 2
FTP-75 Tailpipe bag emission data collected on a ULEV70 vehicle

| Example Systems | NMHC, mg/mile | NOₓ, mg/mile | CO, mg/mile |
|---|---|---|---|
| S1, Comparative | 23.5 | 10.6 | 112 |
| S2 | 23.9 | 9.5 | 104 |
| S3 | 25.2 | 9.8 | 105 |
| S4 | 23.6 | 9.0 | 91 |

Table 2 summarizes the tailpipe emissions of NMHC, NOx, and CO acquired on the ULEV70 test vehicle. Example System 1 represents a conventional TWC system in which both the upstream and the downstream catalysts were based on Pd and Rh as the active platinum group metals. Example System 2 comprises a Pt/Pd/Rh-based trimetal upstream TWC and a single-coat Pt/Rh-based monolayer downstream TWC. System 2 exhibited equivalent NMHC and CO emissions as well as slightly better NOx emissions in comparison with the reference System 1. Example System 4 is similar to System 2, except that the downstream TWC is a Pt/Pd/Rh-based trimetal catalyst. System 4 exhibited comparable performance to System 2. Both Systems 2 and 4 used a substantial amount of Pt to replace the more expensive Pd existing in the reference system. In addition, a low backpressure loss, single-coat downstream catalyst was applied in these invention systems. As a result, these invention systems are substantially more cost effective than the reference system. Example System 3 employed remarkably more ceria in the downstream TWC, which gave rise to a moderate loss in NMHC performance.

The result for FTP-75 Tailpipe bag emission data for systems S5-S6 is provided in the following Table No. 3:

TABLE 3
FTP-75 Tailpipe bag emission data collected on a SULEV30
vehicle calibrated with frequent fuel-cut events

| Example Systems | NMHC, mg/mile | NOₓ, mg/mile | CO, mg/mile |
|---|---|---|---|
| S5, Comparative | 9.2 | 15.3 | 256 |
| S6 | 9.5 | 11.7 | 251 |

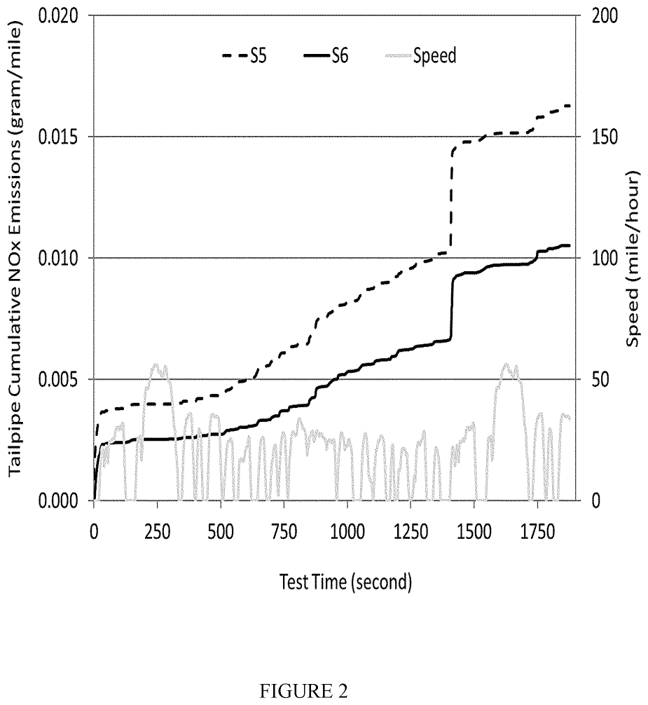

Table 3 summarizes the tailpipe emissions of NMHC, NOx, and CO acquired on the SULEV30 test vehicle. The FTP-75 on this specific vehicle was calibrated with frequent fuel-cut events for better fuel-economy which made the NOx emission control more difficult to achieve. Example System 5 used a Pd/Rh-based downstream TWC. In comparison, the utilization of the Pt/Rh-based single-coat downstream TWC in System 6 gave substantially improved tailpipe NOx emissions at no penalties to NMHC and CO emissions. FIG. 2 illustrated the cumulative NOx emission traces of System 6 versus System 5. The NOx benefit of the invention systems mainly came from the less NOx breakthroughs in the fuel-cut events during deaccelerations.

### CITED LITERATURE

DE 10 2019 208436 A1
US 2010/061903 A1
US 2002/048542 A1
US 2009/042722 A1

1. An exhaust aftertreatment system comprising:
a. a first three-way catalyst deposited at least on a part of a first substrate; and
b. a second three-way catalyst deposited at least on a part of a second substrate, wherein the first three-way catalyst comprises:
I. platinum supported on alumina, ceria-zirconia mixed oxide, ceria-alumina
II. palladium supported on alumina, ceria-zirconia mixed oxide, ceria-alumina composite, or any combination thereof, and
III. rhodium supported on alumina, ceria-zirconia mixed oxide, ceria-alumina composite, or any combination thereof,
wherein the second three-way catalyst comprises platinum supported on alumina, ceria-zirconia mixed oxide, ceria-alumina composite, or any combination thereof.

2. The system according to claim 1, wherein the second three-way catalyst comprises rhodium supported on alumina, ceria-zirconia mixed oxide, ceria-alumina composite, or any combination thereof.

3. The system according to claim 1, wherein the second three-way catalyst is essentially free of palladium.

4. The system according to claim 1, wherein the second three-way catalyst comprises palladium supported on alumina, ceria-zirconia mixed oxide, ceria-alumina composite, or any combination thereof.

5. The system according to claim 1, wherein the weight ratio of platinum supported on alumina, ceria-zirconia mixed oxide, ceria-alumina composite, or any combination thereof in the first three-way catalyst to the platinum supported on alumina, ceria-zirconia mixed oxide, ceria-alumina composite, or any combination thereof in the second three-way catalyst is in the range of 2:1 to 20:1.

6. The system according to claim 1, wherein the weight ratio of the rhodium supported on alumina, ceria-zirconia mixed oxide, ceria-alumina composite, or any combination thereof in the first three-way catalyst to the rhodium supported on alumina, ceria-zirconia mixed oxide, ceria-alumina composite, or any combination thereof in the second three-way catalyst is in the range of 1:1 to 50:1.

7. The system according to claim 1, wherein the weight ratio of the total amount of platinum, palladium and rhodium, each supported on alumina, ceria-zirconia mixed oxide, ceria-alumina composite, or any combination thereof in the first three-way catalyst to the total amount of platinum, optionally with rhodium and palladium-, each supported on alumina, ceria-zirconia mixed oxide, ceria-alumina composite, or any combination thereof in the second three-way catalyst is in the range of 4:1 to 20:1.

8. The system according to claim 1, wherein the system characterized in that the backpressure contribution of the second three-way catalyst is less than 38%.

9. The system according to claim 1, wherein the second three-way catalyst is a single layered catalyst deposited on the second substrate with a total washcoat loading in the range of 1.5 to 3.2 g/in3.

10. The system according to claim 1, wherein the first three-way catalyst is a two layered catalyst comprising a first layer deposited at least on a part of the first substrate and a second layer deposited at least on a part of first layer or on a part of the first substrate or both,
wherein the first layer comprises platinum supported on alumina, ceria-zlrcoma mixed oxide, ceria-alumina composite, or any combination thereof; and palladium supported on alumina, ceria-zirconia mixed oxide, ceria-alumina composite, or any combination thereof,
wherein the second layer comprises rhodium supported on alumina, ceria-zirconia mixed oxide, ceria-alumina composite, or any combination thereof.

11. The system according to claim 1, wherein the first three-way catalyst is a two layered catalyst comprising a first layer and a second layer,
wherein the first layer comprises a first zone and a second zone,
wherein the first zone covers 10 to 90% of the entire substrate length from an inlet and the second zone covers 10 to 90% of the entire substrate length from an outlet,
wherein the first zone comprises palladium supported on alumina, ceria-zirconia mixed oxide, ceria-alumina composite, or any combination thereof,
wherein the second zone comprises platinum supported on alumina, ceria-zlrcoma mixed oxide, ceria-alumina composite, or any combination thereof, and palladium supported on alumina, ceria-zirconia mixed oxide, ceria-alumina composite, or any combination thereof wherein the second layer is deposited at least on a part of the first layer, wherein the second layer comprises rhodium supported on alumina, ceria-zirconia mixed oxide, ceria-alumina composite, or any combination thereof.

12. The system according to claim 1, wherein the total ceria-zirconia mixed oxide loading in the first three-way catalyst is higher than the total ceria-zirconia mixed oxide loading in the second three-way catalyst.

13. The system according to claim 1, wherein the total amount of platinum supported on alumina, ceria-zirconia mixed oxide, ceria-alumina composite, or any combination thereof in the first three-way catalyst and the second three-way catalyst is in the range of 0.02 to 3.0 wt. %, based on the total weight of the first three-way catalyst and the second three-way catalyst.

14. The system according to claim 1, wherein the total amount of palladium supported on alumina, ceria-zirconia mixed oxide, ceria-alumina composite, or any combination thereof in the first three-way catalyst and the second three-way catalyst is in the range of 0.02 to 3.0 wt. %, based on the total weight of the first three-way catalyst and the second three-way catalyst.

15. The system according to claim 1, wherein the total amount of rhodium supported on alumina, ceria-zirconia mixed oxide, ceria-alumina composite, or any combination thereof in the first three-way catalyst and the second three-way catalyst is in the range of 0.01 to 2.0 wt. %, based on the total weight of the first three-way catalyst and the second three-way catalyst.

16. The system according to claim 1, wherein the substrate is selected from a ceramic substrate, a metal substrate, a ceramic foam substrate, a polymer foam substrate, or a woven fiber substrate.

17. The system according to claim 1, wherein the total amount of the ceria-zirconia mixed oxide present in the first three-way catalyst and the second three-way catalyst is 40 to 60 wt. %, based on the total weight of the first three-way catalyst and the second three-way catalyst.

18. The system according to claim 1, wherein the total amount of the alumina present in the first three-way catalyst and the second three-way catalyst is in the range of 5.0 to 20 wt. %, based on the total weight of the first three-way catalyst and the second three-way catalyst, or wherein the total amount of the alumina present in the first three-way catalyst and the second three-way catalyst is in the range of 15 to 60 wt. %, based on the total weight of the first three-way catalyst and the second three-way catalyst.

19. The system according to claim 1, wherein the alumina present in the first three-way catalyst and the second three-way catalyst is doped with a dopant selected from barium, lanthana, zirconia, neodymian, yttria, ceria or titania, wherein the amount of the dopant is 1.0 to 30 wt. % based on the total weight of the alumina and dopant present in the first three-way catalyst or the second three-way catalyst.

20. The system according to claim 1, wherein alumina is selected from alumina, lanthana-alumina, titania-alumina, ceria-zirconia-alumina, zirconia-alumina, ceria-alumina, lanthana-zirconia-alumina, baria-alumina, baria-lanthana-alumina, baria-lanthana-neodymia-alumina, yttrium-alumina, or any combination thereof.

21. The system according to claim 1, wherein the total amount of the ceria-alumina composite present in the first three-way catalyst and the second three-way catalyst is in the range of 15 to 40 wt. %, based on the total weight of first three-way catalyst and the second three-way catalyst.

22. The system according to claim 1, wherein the system comprises:
i) an engine producing an exhaust gas stream;
ii) a first three-way catalyst deposited at least on a part of a first substrate; and
iii) a second three-way catalyst deposited at least on a part of a second substrate,
wherein the first three-way catalyst is positioned upstream from the engine and the second three-way catalyst is positioned downstream in fluid communication with the first three-way catalyst.

23. The system according to claim 1, wherein the amount of the ceria-alumina composite present in the first three-way catalyst and the second three-way catalyst is in the range of 5.0 to 80 wt. %, and the amount of the ceria-zirconia mixed oxide present in the first three-way catalyst and the second three-way catalyst is 20 to 80 wt. %, based on the total weight of the first three-way catalyst and the second three-way catalyst, and
wherein the amount of CeO2 in the ceria-alumina composite present in the first three-way catalyst or the second three-way catalyst is preferably 1.0 to 60 wt. %, based on the total weight of the ceria-alumina composite in the respective catalyst, wherein CeO2 of the ceria-zirconia mixed oxide present in the first three-way catalyst or the second three-way catalyst is present in an amount of 10 to 60 wt. %, based on the total weight of the ceria-zirconia mixed oxide present in the respective catalyst and zirconia (calculated as ZrO2) of the ceria-zirconia mixed oxide present in the first three-way catalyst or the second three-way catalyst is present in an amount of 40 to 90 wt. %, based on the total weight of the ceria-zirconia mixed oxide present in the respective catalyst.

24. A method of reducing hydrocarbons, carbon monoxide, and nitrogen oxide levels in a gaseous exhaust stream, the method comprising contacting a gaseous exhaust stream with exhaust aftertreatment system according to claim 1 to reduce the levels of hydrocarbons, carbon monoxide, and nitrogen oxide in the exhaust gas.

25. (canceled)
